(19) United States
(12) Patent Application Publication
(10) Pub. No.: US 2011/0014938 A1
(43) Pub. Date: Jan. 20, 2011

(54) ASYMMETRIC BANDS ALLOCATION IN DOWNLINK AND UPLINK USING THE SAME FFT SIZE

(75) Inventor: Parwiz Shekalim, Netanya (IL)

Correspondence Address: ROBERT G. LEV, 4766 MICHIGAN BLVD., YOUNGSTOWN, OH, 44505, US

(73) Assignee: Runcom Technologies Ltd., Rishon Lezion (IL)

(21) Appl. No.: 12/920,693

(22) PCT Filed: Mar. 6, 2009
(86) PCT No.: PCT/IB09/50940

§ 371 Date: Sep. 2, 2010

Related U.S. Application Data
(60) Provisional application No. 61/034,200, filed on Mar. 6, 2008.

(51) Int. Cl. H04W 72/04

(52) U.S. Cl. 455/509

(57) ABSTRACT

Creating asymmetric wireless communication by Allocating a first plurality of frequency bands to a first transmission direction and at least one frequency band to an opposite transmission direction where all the frequency bands use the same FFT size Dividing at least one of the frequency bands into sub-bands or slots Creating an asymmetrical communication channel including at least one of A whole number of the frequency bands in one direction and at least one of the sub-bands in the opposite direction A first number of the sub-bands in one direction and a different number of the sub-bands in the opposite direction At least one sub-band in one direction and at least one sub-band in the opposite direction having different size.

### CROSS-REFERENCE TO RELATED APPLICATIONS

The present application claims priority from U.S. provisional patent application 61/034,200, filed Mar. 6, 2008, the contents of which are hereby incorporated by reference.

### FIELD AND BACKGROUND OF THE INVENTION

The present invention relates to systems and methods for wireless communication and, more particularly, but not exclusively to wireless communication OFDMA based wireless communication using the same size of Fast Fourier Transform (FFT) in uplink and downlink flow directions.

In common applications of wireless communication the traffic flow is usually asymmetric, meaning the volume of traffic in one direction is much smaller or larger than in the opposite direction. For example, in video and radio (audio) broadcasting and/or multicasting the traffic in the downlink (DL) direction, from the broadcaster to the terminal, is much higher than in the opposite direction. In application involving Internet browsing most of the traffic is again in the downlink direction from the application servers or from the ISP (Internet Service Provider) site to the user terminals. Therefore, for these specific examples, more bandwidth is required in downlink direction compared with the uplink direction. In some other systems such as Video security, the traffic is mostly in the uplink (UL) direction. Therefore, again, the traffic is asymmetric and allocation of more resources is required in one of the directions.

According to the IEEE802.16 standards (including IEEE802.16e, IEEE802.16j, etc.) the same FFT size should be configured and used for both downlink and uplink direction for both TDD and FDD systems.

The TDD-based systems, such as the IEEE802.16 standard (and WiMAX Forum), enable dynamic allocation of radio resources in downlink and in uplink sub-frames of each TDD frame. For example, for 5 msec TDD frame structure with 47 symbols can be configured with a ratio of 32 symbols in downlink and 15 symbols in uplink. Other downlink/uplink ratios can also be configured. It is noted that the same FFT size is used for both downlink and uplink directions, irrespectively of the downlink/uplink ratio.

For FDD systems, symmetric or asymmetric spectrum bands may be allocated, meaning that paired or unpaired spectrums with different channel bandwidths may be allocated for downlink and uplink. However, the same FFT size should be used for downlink and uplink of a system, which limits the use of asymmetric channel bandwidth allocation. Furthermore, even for symmetric allocation of FDD bands, a part of the uplink spectrum can be used for other services or network applications, such as for ad-hoc or mesh networking, or for TDD mode operation. Therefore, different channel bandwidths may be allocated for downlink and uplink. Therefore, the uplink and the downlink may require different FFT sizes, which is not provided by the current art.

There is thus a widely recognized need for, and it would be highly advantageous to have, a wireless communication system and method devoid of the above limitations.

### SUMMARY OF THE INVENTION

According to one aspect of the present invention there is provided a method of asymmetric wireless communication. The method preferably includes the steps of: allocating a first plurality of frequency bands to a first transmission direction and at least one frequency band to a second transmission direction, the second transmission direction being opposite to the first transmission direction, and where all the frequency bands use the same FFT size; dividing at least one of the frequency bands into sub-bands; creating an asymmetrical communication channel including at least one of: a whole number of the frequency bands in one direction and at least one of the sub-bands in the opposite direction; a first number of the sub-bands in one direction and a different number of the sub-bands in the opposite direction; at least one of the sub-bands in one direction and at least one of the sub-bands in the opposite direction where the sub-bands in different directions have a different size; and at least one frequency band and at least one sub-band in one direction and a different number of at least one of the frequency bands and the sub-bands in the opposite direction.

According to another aspect of the present invention there is provided a method of asymmetric wireless communication including the steps of: allocating a first frequency band to a first network device for transmitting information, and a portion of a second frequency band for receiving information; and allocating a third frequency band to a second network device for transmitting information, and another portion of the second frequency band for receiving information; where the first network device and the second network device use same FFT size for the first frequency band the second frequency band and the third frequency band.

According to yet another aspect of the present invention there is provided a method of asymmetric wireless communication including the steps of: allocating a first frequency band to a first network device for receiving information, and a portion of a second frequency band for transmitting information; and allocating a third frequency band to a second network device for receiving information, and another portion of the second frequency band for transmitting information; where the first network device and the second network device use same FFT size for the first frequency band the second frequency band and the third frequency band.

According to still another aspect of the present invention there is provided a method of asymmetric wireless communication where transmissions of the first network device and the second network device are synchronized.

Also, according to another aspect of the present invention there is provided a method of asymmetric wireless communication where at least one of the first frequency band, the second frequency band and the third frequency band includes a plurality of frequency sub-bands, and where aggregated bandwidth allocation for transmitting is different from aggregated bandwidth allocated for receiving.

Additionally, according to another aspect of the present invention there is provided a method of asymmetric wireless communication where the frequency bands and the frequency sub-bands are allocated same FFT size.

Further according to another aspect of the present invention there is provided a method of asymmetric wireless communication where at least one of the frequency bands and the frequency sub-bands are at least one of adjacent and separated by at another frequency band and/or another frequency sub-band.

Still further according to another aspect of the present invention there is provided a method of asymmetric wireless communication including the steps of: aggregating at least one of a plurality of frequency bands in the downlink and a plurality of frequency bands in the uplink to form at least one frequency aggregation; dividing the at least one frequency aggregation into frequency sub-bands; allocating frequency sub-bands to at least one communication device wherein a different number of frequency sub-bands is allocated in the downlink and the uplink to form asymmetric wireless communication; using same FFT size for both downlink and uplink transmissions.

Even further according to another aspect of the present invention there is provided a wireless communication device for asymmetrical wireless communication, the wireless communication device including: a receiver module for receiving communication transmission; and a transmission module for transmitting communication transmission; where at least one of: the receiver module is operative to use a sub-band to receive the communication transmission; and the transmission module is operative to use a sub-band and/or major groups to transmit the communication transmission; and where the wireless communication device is allocated at least one of: a whole number of frequency bands in one direction and at least one sub-band in the opposite direction; a first number of sub-bands in one direction and a different number of sub-bands in the opposite direction; at least one sub-band in one direction and at least one sub-band in the opposite direction where the sub-bands in different directions have a different size; and at least one frequency band and at least one sub-band in one direction and a different number of at least one of frequency bands and sub-bands in the opposite direction; where said sub-bands are portions of a frequency band allocated in time and/or frequency plain and all the frequency bands have the same bandwidth and/or FFT size.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may vary without changing the purpose or effect of the methods described.

Implementation of the method and system of the present invention involves performing or completing certain selected tasks or steps manually, automatically, or any combination thereof. Moreover, according to actual instrumentation and equipment of embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified-illustration of an asymmetric wireless communication system;

FIG. 2 is a simplified illustration of another asymmetric communication network using a single base station;

FIG. 3 is a simplified illustration of an asymmetric allocation of two downlink bands with a single uplink band;

FIG. 4 is a simplified illustration of an aggregation of two downlink bands with a corresponding single uplink band, all having the same FFT size;

FIG. 5 is a simplified illustration of a management system managing the two integrated base-band parts as a single logical base-station in an asymmetric communication network;

FIG. 6 a simplified illustration of the aggregation of several downlink bands using a single uplink band in an asymmetric communication network; and

FIG. 7 is a simplified illustration of aggregation of several downlink bands using several uplink bands in an asymmetric communication network.

### DETAILED DESCRIPTION OF THE INVENTION

The present embodiments comprise a wireless communication system and method used for asymmetric channel band allocation for asymmetric traffic capacity. It is appreciated that the present embodiments may be also capable of symmetric traffic capacity.

The principles and operation of an asymmetric wireless communication system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The objective of the present invention is to enable asymmetric wireless communication, preferably under the limitations of conventional wireless communication standards. In this respect, the wireless communications standards refer to the IEEE802.16 family of standards, also may be known as WiMAX, as well as other communications standards based on OFDM or OFDMA communication technologies.

Such standards define standard sizes of bandwidth, such as 5 MHz, 10 MHz, 20 MHz, etc. These standards also define standard FFT sizes such as 512, 1024, or 2048 FFT size, etc. Furthermore, the standards define a relation between the bandwidth and the FFT size, for example, requiring the use of FFT size of 512 with the bandwidth of 5 MHz, and/or the use of FFT size of 1024 with the bandwidth of 10 MHz. Such standards also require that the same FFT size is used in the uplink and the downlink. These two requirements present a problem for the implementation of asymmetric communication.

Wireless networks and methods designed for voice communication are usually symmetrical, since the same traffic and bit-rate is required in both directions. However, in broadcasting and in data networks the traffic may be highly asymmetrical. For example, in video and radio (audio) broadcasting and/or multicasting the traffic in the downlink (DL) direction, from the broadcaster to the terminal, is much higher than in the opposite direction. In application involving Internet browsing most of the traffic is again in the downlink direction from the application servers or from the ISP (Internet Service Provider) site to the user terminals. Therefore, for these specific examples, more bandwidth is required in downlink direction compared with the uplink direction. In some other systems such as Video security, the traffic is mostly in the uplink (UL) direction. Therefore, again, the traffic is asymmetric and allocation of more resources is required in one of the directions.

However, the current wireless communication methods and standards are inappropriate for asymmetrical communication, and do not support asymmetric channel bands in downlink and uplink. For example, the allocation of 10 MHz in the downlink and a bandwidth of 5 KHz in the uplink is impossible, as the FFT size of 1024 should be used in the downlink and FFT size of 512 should be used in the uplink, and since the standard forbids the use of different FFT sizes in the uplink and the downlink. The present inventions enables the allocation of different bandwidth in the downlink and the uplink while using the same FFT size in the uplink and the downlink, and while preserving the association of bandwidth and FFT size (for example, 5 MHz and 512 FFT size).

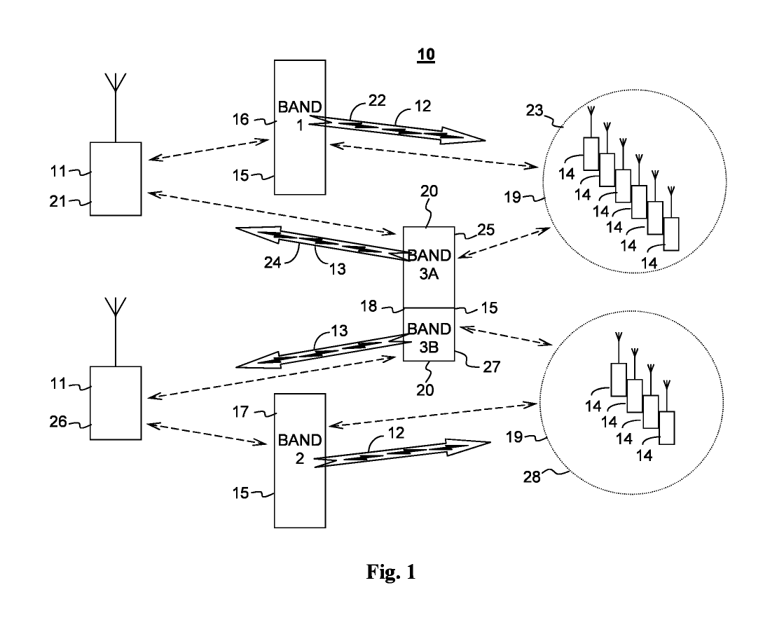

Reference is now made to FIG. 1, which is a simplified illustration of an asymmetric wireless communication system 10 according to an embodiment of the present invention.

As seen in FIG. 1, the asymmetric wireless communication system 10 preferably includes a plurality of network devices 11 termed herein “base-stations”, transmitting in the downlink 12 and receiving in the uplink 13, and a plurality of network devices 14 termed herein “user-terminals”, transmitting in the uplink and receiving in the downlink.

As seen in FIG. 1, the asymmetric wireless communication system 10 preferably includes a plurality of FDD frequency bandwidths 15. Preferably the frequency bandwidths are of the same size and are defined with the same Fast Fourier Transform (FFT) size. As seen in FIG. 1, the frequency bandwidths 15 are allocated asymmetrically, for example: two bands 16 and 17 are used for DL versus one band 18 in UL. Typically, more frequency bandwidths 15 are allocated to the downlink then to the uplink. However, reverse asymmetry is also possible, where more frequency bandwidths 15 are allocated to the uplink then to the downlink.

As seen in FIG. 1 the user terminals 14 are preferably grouped into a plurality of groups 19. The groups 19 can contain the same number of user-terminals 14 or a different number of user-terminals 14. Typically, each group 19 of user-terminals 14 communicates with a specific base-station 11.

It is appreciated that a user-terminal 14 can communicate with a plurality of base-stations 11, for example, for different applications, such as unicast communication with a first base-station 11 and multicast communication with a second base-station 11.

As seen in FIG. 1 each base-station 11 is allocated a bandwidth 15 for transmitting in the downlink 12. It is appreciated that a plurality of bandwidths 15 can be allocated to each base-station 11. It is further appreciated that each base-station 11 can be allocated a different number of bandwidths 15. Typically, resources of bandwidths 15 are allocated for the base-stations 11 simultaneously.

As seen in FIG. 1 a bandwidth in the uplink is allocated to two (or more) base-stations or base-station modules 11. In this example, each group 19 of user-terminals 14 is allocated a bandwidth part, designated by numeral 20, of bandwidth 18, for transmitting in the uplink 13. It is appreciated that a plurality of bandwidth parts 20 can be allocated to each group 19 of user-terminals 14, or, alternatively a whole number of bandwidths 15 plus at least one bandwidth part 20 can be allocated to a group 19 of user-terminals 14. Preferably, the aggregated size, or capacity, of bandwidths 15 and bandwidth parts 20 allocated for the downlink 12 is different from the aggregated size, or capacity, of bandwidths 15 and bandwidth parts 20 allocated for the uplink 13 for a pair of base-station 11 and group 19

It is appreciated that each base-station 11 is allocated for receiving in the uplink 13 the bandwidth that is allocated to the corresponding group 19 for transmission in the uplink, and that each group 19 is allocated for receiving in the downlink the same bandwidth that is allocated to the base-station 11 for transmission in the downlink 12.

For example, the base-station 11 designated by numeral 21 is allocated for transmission in the downlink 12 designated by numeral 22 the bandwidth 16, which is allocated to group 19 designated by numeral 23 for receiving in the downlink 22.

Respectively, the base-station 21 is allocated reception in the uplink 13 designated by numeral 24 the bandwidth part 20 designated by numeral 25, which is allocated to group 23 for transmission in the uplink 24

Thus, in the FDD asymmetric wireless communication system 10, different capacities are allocated to the downlink 12 and the uplink 13 in at least some of the pairs of base-station 11 and group 19. Preferably, within each pair of base-station 11 and group 19, the base-station 11 and the user-terminals 14 use the same FFT size for both the downlink 12 and the uplink 13, in spite of their unequal capacities. Preferably, all bandwidths 15 in use by the asymmetric wireless communication system 10 are of equal size and/or are defined with the same FFT size.

The asymmetric wireless communication system 10 preferably uses uplink Partial Usage of Sub-Channels (PUSC) or AMC bands feature to enable asymmetric allocation of channel spectrum in the downlink and the uplink.

For PUSC in the downlink, all the sub-carriers are first divided into the major groups (as specified by the IEEE standard). Permutation of sub-carriers to create sub-channels is performed independently within each major group. Thus, logically separating each group from the others.

In PUSC, it is possible to allocate all major groups, or only a subset of the major groups, to a particular transmitter. By allocating disjoint subsets of the available major groups to neighboring transmitters it is possible to separate their signals in the sub-carrier space, thus, enabling a tighter frequency reuse at the cost of data rate. Such usage of sub-carriers is referred to as segmentation. It should be noted that although segmentation can be used with PUSC, PUSC by itself does not demand segmentation.

In uplink PUSC, the sub-carriers are first divided into several tiles. Typically, each tile contains of four sub-carriers over three symbols of orthogonal frequency division multiplexing (OFDM). Alternatively, each tile contains three sub-carriers over three OFDM symbols. Uplink PUSC can be used with segmentation to enable the asymmetric wireless communication system 10 to operate under tighter frequency reuse patterns.

The proposed solution uses UL PUSC feature in order to allow asymmetric allocation of Channel Spectrum in DL and UL.

For the DL PUSC, all the sub-carriers are first divided into several major groups. Permutation of sub-carriers to create sub-channels is performed independently within each major group, thus logically separating each group from the others.

Unique to the band AMC permutation mode, all sub-carriers constituting a sub-channel are adjacent to each other. Since the dynamic nature of the wireless channel, different users are allocated to the sub-channel at different instants. An AMC sub-channel typically consists of six contiguous bins from within the same band. Thus, an AMC sub-channel can typically consist of one bin over six consecutive symbols, two consecutive bins over three consecutive symbols, or three consecutive bins over two consecutive symbols.

As seen in FIG. 1, the asymmetric wireless communication system 10 uses frequency bands 15 of the same bandwidth size and FFT size, for example, 10 MHz and 1024, respectively, for the downlink and the uplink. However, both base-stations 11 are allocated asymmetrical bandwidth in the downlink and the uplink. As seen in FIG. 1, base-station 21 is allocated frequency band 16 in the downlink, and the portion 25 of frequency band 18 in the uplink. Respectively, user terminals 14 of group 23, which communicate with the base-station 21, are allocated frequency band 16 in the downlink, and the portion 25 of frequency band 18 in the uplink.

It is appreciated that a portion 25 of a frequency band preferably contains a group of sub-carriers in the frequency band, or a sub-channel, or a group of sub-channels. The portions 25 are also termed herein sub-bands.

For the concept of this document the term “sub-band” refereed to any air interface resource allocation techniques where part of the air interface resource is allocated for a user terminal, or for a session, or group of user terminals, or a group of sessions, etc., such as sub-bands, or slots, or time-slots, or resource blocks, etc., for example according to the IEEE802.16 standard.

Thus, for the base-stations 11, the method of asymmetric wireless communication includes the steps of:
Allocating a first frequency band, e.g. frequency band 16, to a first network device, e.g. base-station 21, for transmitting information, e.g. in the downlink 22.
Allocating a portion of a second frequency band, e.g. portion 25 of frequency band 18, for receiving information. E.g. in the uplink 24.

Additionally but optionally, the method of asymmetric wireless communication includes the steps of:
Allocating a third frequency band, e.g. frequency band 17, to a second network device, e.g. base station 26, for transmitting information (e.g. in the downlink).
Allocating another portion of the second frequency band, e.g. portion 27 of frequency band 18, for receiving information, e.g. in the uplink.

Furthermore, the method of asymmetric wireless communication includes the steps of:
Allocating the first network device and the second network device the same FFT size for the first frequency band the second frequency band and the third frequency band.

Respectively, for the user-terminals 14, the method of asymmetric wireless communication includes the steps of:
Allocating a first frequency band, e.g. frequency band 16, to a first network device, or a group of network devices, e.g. group 23 of user-terminals 14, for receiving information, e.g. in the downlink 22
Allocating a portion of a second frequency band, e.g. portion 25 of frequency band 18, for transmitting information. E.g. in the uplink 24.

Additionally but optionally, the method of asymmetric wireless communication includes the steps of:
Allocating a third frequency band, e.g. frequency band 17, to a second network device, or a group of network devices, e.g. group 28 of user-terminals 14, for receiving information (e.g. in the downlink).
Allocating another portion of the second frequency band, e.g. portion 27 of frequency band 18, for transmitting information, e.g. in the uplink.

Furthermore, the method of asymmetric wireless communication includes the steps of allocating the first (group of) network device(s) and the second (group of) network device(s) the same FFT size for the first frequency band the second frequency band and the third frequency band.

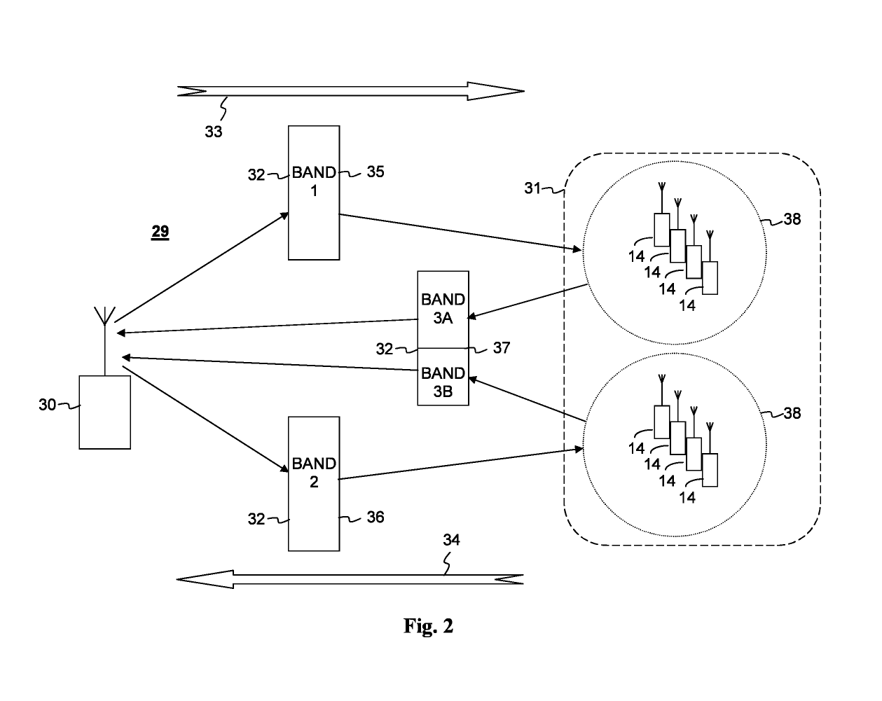

Reference is now made to FIG. 2, which is a simplified illustration of an asymmetric communication network 29 with a single base station 30, according to an embodiment of the present invention.

As seen in FIG. 2, the single base-station 30 serves a plurality 31 of user terminals 14. The base-station 30 is preferably allocated three (or more) frequency bandwidths 32. Preferably, these frequency bandwidths (e.g. 10 MHz) use the same FFT size (e.g. 1024).

Preferably, an unequal number of frequency bandwidth is allocated in the downlink 33 and the uplink 34. As seen in FIG. 2, two bandwidths 32 (designated by numeral 35 and 36) are allocated in the downlink and one bandwidth is allocated in the uplink (designated by numeral 37). It is appreciated that the larger number of frequency bands can be allocated in the uplink 34 instead of the downlink 33, according to the application requirements, such as with video surveillance.

The base-station 30 preferably divides the plurality 31 of user terminals 14 into two (or more) groups 38 of user terminals 14. The base-station 30 preferably allocate one downlink frequency band and a portion of the uplink frequency band 37 to each group 38, thus creating an asymmetrical wireless communication network that uses frequency bands of the same bandwidth size and FFT size.

It is appreciated that more than two groups 38 can be created. It is appreciated that that more than one frequency band 32 can be allocated to a particular group in the downlink. It is appreciated that that more than one portion, of more than one frequency band, can be allocated to a particular group 38 in the uplink. Thus, creating a complex scheme of asymmetrical bandwidth allocation with different ratios of asymmetrical bandwidth allocations according to application needs. It is therefore appreciated that a single base-station (or a group of base-stations) can maintain bi-directional asymmetric communication where some groups of user-terminals 14 have larger downlink bandwidths, and other groups of user-terminals 14 have larger uplink bandwidths.

It is also appreciated that for some applications asymmetric bandwidth allocation can include zero bandwidth allocation for one transmission direction. For example, a group of user-terminals 14 using a multicast or a broadcast application can be allocated bandwidth in the downlink only, and zero bandwidth in the uplink.

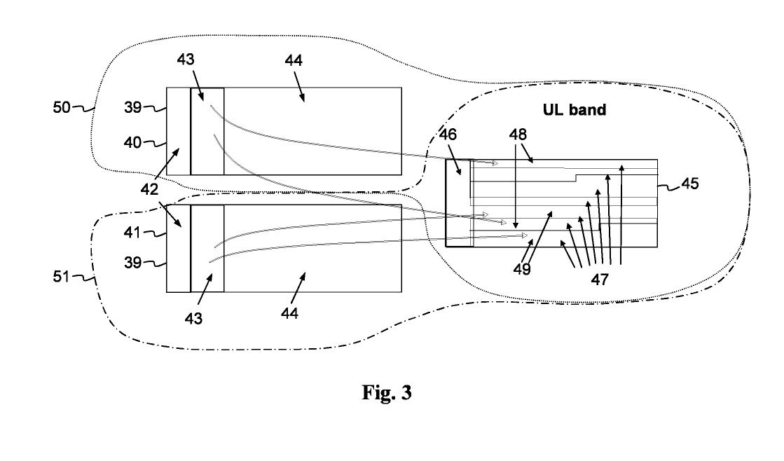

Reference is now made to FIG. 3, which is a simplified illustration of an asymmetric allocation of two downlink bands with a single uplink band, according to an embodiment of the present invention.

The asymmetric wireless communication system 10 enables aggregation (concatenation or combination) of multiple downlink bands (channel bandwidth) and/or aggregation of multiple uplink bands, enabling asymmetric spectrum allocation in downlink versus uplink, while using the same FFT size for both downlink and uplink. The aggregated bands in the downlink or in the uplink may be adjacent, or nonadjacent from different areas of the RF spectrum (and hence, separated by other frequency bands). Such solution can be deployed for Reuse 1, Reuse<1, or Reuse>1, when all or part of the slots of a downlink band can be dedicated to a single sector (or, for example, to all sectors using PUSC segmentation scheme). However, slots of a single uplink band (or more) are shared and dedicated to several downlink bands. FIG. 3 illustrates a combination of two downlink band shared with a single uplink band.

As seen in FIG. 3, the each of the two downlink bands 39 (DL1 40 and DL2 41) preferably contain a preamble part 42, a MAP part 43 and a content part 44. The uplink band 45 preferably contains CDMA, feedback information and other uplink control messages 46 and data bursts 47. Part of the uplink bandwidth, such as data bursts 48 are allocated to the uplink corresponding to the downlink DL1 40, while another part of the uplink bandwidth, such as data bursts 49 are allocated to the uplink corresponding to the downlink DL2 41. Thus creating an asymmetrical bandwidth allocation in the downlink and uplink of the two communication channels 50 and 51.

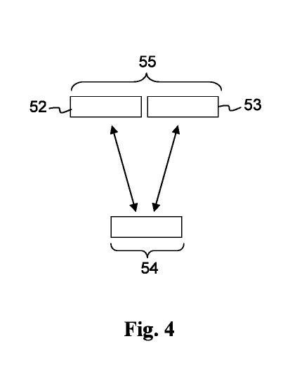

Reference is now made to FIG. 4, which is a simplified illustration of an aggregation of two downlink bands 52 and 53 with a corresponding single uplink band 54, all having the same FFT size, according to an embodiment of the present invention.

It is appreciated that the band configuration of FIG. 4 is an example of one of a plurality of possible band configurations, as the two bands 52 and 53 may be used for uplink and band 54 for downlink.

As seen in FIG. 4, the two downlink bands 52 and 53, for example comprising ChBW1 and Ch-BW2, are preferably concatenated to form the downlink frequency band 55 (F1) while the uplink comprises the single band 54, such as Ch-BW7. For example, the downlink frequency band 55 contains two bands of 10 MHz and the uplink band 54 also contains a 10 MHz band. PUSC and/or AMC segmentation or sub channelization schemes are preferably used to keep the same FFT size in the downlink and the uplink. Therefore, a single uplink band corresponds to the two downlink bands. It is appreciated that the two downlink bands may be adjacent in the same spectrum carrier, or non-adjacent from different areas of the spectrums (e.g. separated by other frequency bands).

Various reuse factors may be deployed and various implementation solutions may be used. Since each of the downlink bands corresponds to a single uplink band the same FFT size is used for both uplink and downlink. In the downlink bands, any number of major groups, as, for example, is specified in IEEE802.16, can be allocated in each band.

A simple implementation can use two units of base-station modules that are managed, controlled and synchronized by an internal or an external management system. The management system controls and synchronizes the two modules and provides allocation of slots. The management system may be implemented internally in the base-station. Alternatively, an external management system can be used in the ASN-GW or elsewhere in the network.

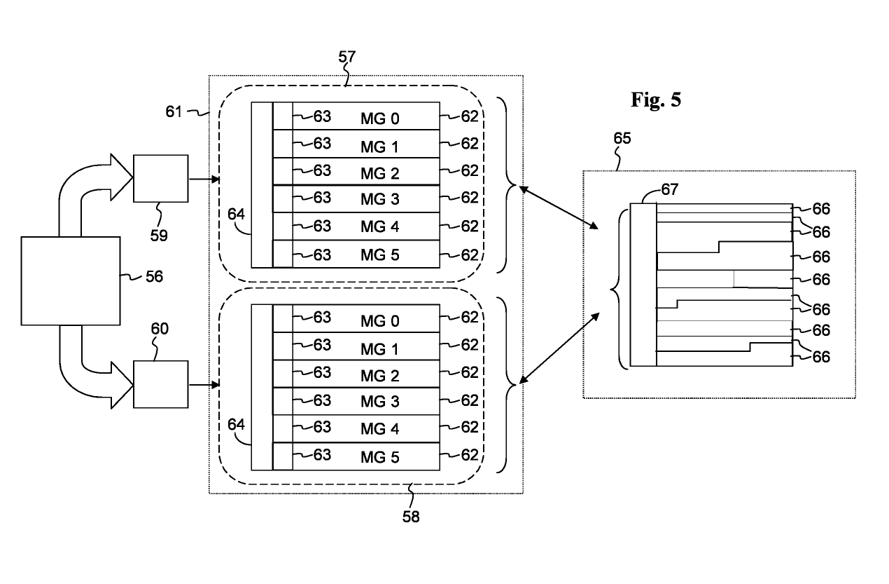

Reference is now made to FIG. 5, which is a simplified illustration of a management system 56 managing the two integrated base-band parts 57 and 58 as a single logical base-station according to an embodiment of the present invention

As seen in FIG. 5, the management system 56 preferably controls two (or more) base-station modules 59 and 60, controlling respective base-band parts 57 and 58 in the downlink. The base-station modules 59 and 60 can be, for example, WiMAX base-station sector controller modules. The management system 56 can be an external or an internal management system.

The base-station modules 59 and 60 preferably manage a respective base-band 57 and 58 in the downlink 61. Each base-band in the downlink 61 preferably contains major-groups (MG) 62, a broadcasting MAP 63 per each major group, and a preamble 64. The management system 56 preferably shares the available slots in the downlink frame between the two downlink frames. The corresponding uplink 65 preferably contains a plurality of uplink bursts 66 and corresponding CDMA and feedback information 67. The management system 56 preferably shares the available slots in the uplink frame between the two downlink frames.

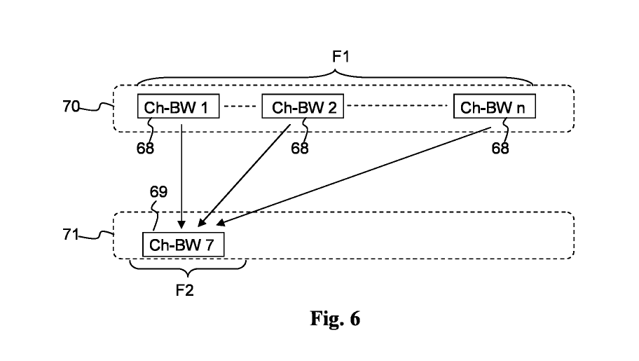

Reference is now made to FIG. 6, which is a simplified illustration of the aggregation of several downlink bands using a single uplink band according to an embodiment of the present invention.

FIG. 6 shows an asymmetric allocation of downlink versus uplink bands where several adjacent or non-adjacent downlink bands 68 are preferably aggregated to create of one large downlink band, while using a single band 69 is in the uplink. Each of the downlink bands 68 and the uplink band 69 have the same FFT size. For example according to the IEEE802.16 definitions. It is noted that in this way the asymmetric wireless communication system 10 enables the same FFT size for the aggregated downlink channels and the uplink band by using the uplink PUSC sub-channelization scheme. It is appreciated that a single base-band module may be used for each of the downlink bands 68 and the uplink band 69. It is also appreciated that all the base-bands can be controlled so that the uplink sub-frame is used for all the downlink bands and the uplink slots are shared for all the downlink bands using uplink PUSC or uplink optional PUSC schemes.

Alternatively, the asymmetric wireless communication system 10 can enable the aggregation of several downlink bands using several aggregated uplink bands. In this configuration, several adjacent or nonadjacent bands may be used to create a large aggregated downlink band, typically selected from the downlink frequency spectrum 70. Correspondingly, few or several uplink bands can be aggregated for the uplink aggregated band, typically selected from the downlink frequency spectrum 71. This configuration enables the same FFT size for downlink and the uplink even when the aggregated downlink bands is larger or even smaller than the uplink aggregated band. Preferably, each downlink band is controlled by a base-band module, but all with the same FFT size. All base-band modules are preferably logically combined by a single management system that controls and synchronizes the allocation of resources and slots in downlink and the uplink frames. The slots of all or each of the uplink Ch-BW are shared by the downlink Ch-BWs.

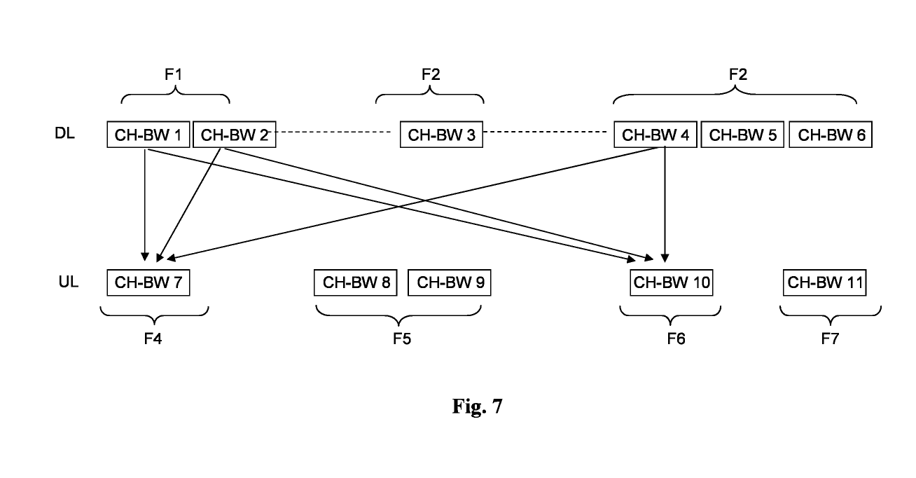

Reference is now made to FIG. 7, which is a simplified aggregation of several downlink bands, and using several uplink bands, in an asymmetric communication network, according to an embodiment of the present invention.

As seen in FIG. 7, the proposed solution enables combination or concatenation of several Ch-BW from a single or several RF carriers for DL transmission, with single or several Ch-BW from a single or several RF carriers used for UL transmission, still using the same FFT size for both DL and UL transmission.

It is expected that during the life of this patent many relevant wireless devices and systems will be developed and the scope of the terms herein, particularly of the terms “uplink”, “downlink” and “FFT size”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of asymmetric wireless communication comprising the steps of:
allocating a first plurality of frequency bands to a first transmission direction and at least one frequency band to a second transmission direction, the second transmission direction being opposite to said first transmission direction, and wherein all said frequency bands have the same bandwidth and use the same FFT size;
dividing at least one of said frequency bands into sub-bands;
creating an asymmetrical communication channel comprising at least one of:
a whole number of said frequency bands in one direction and at least one of said sub-bands in the opposite direction;
a first number of said sub-bands in one direction and a different number of said sub-bands in the opposite direction;
at least one of said sub-bands in one direction and at least one of said sub-bands in the opposite direction wherein said sub-bands in different directions have a different size; and
at least one frequency band and at least one sub-band in one direction and a different number of at least one of said frequency bands and said sub-bands in the opposite direction.

2. A method of asymmetric wireless communication comprising the steps of:
allocating a first frequency band to a first network device for transmitting information, and a portion of a second frequency band for receiving information; and
allocating a third frequency band to a second network device for transmitting information, and another portion of said second frequency band for receiving information;
wherein said first network device and said second network device use same FFT size for said first frequency band said second frequency band and said third frequency band.

3. (canceled)

4. A method of asymmetric wireless communication according to any of claims 2 and 3 wherein transmissions of said first network device and said second network device are synchronized.

5. A method of asymmetric wireless communication according to any of claims 2 and 3 wherein at least one of said first frequency band, said second frequency band and said third frequency band comprises a plurality of frequency sub-bands, and wherein aggregated bandwidth allocation for transmitting is different from aggregated bandwidth allocated for receiving.

6. A method of asymmetric wireless communication according to claim 5 wherein said frequency bands and said frequency sub-bands are allocated same FFT size.

7. A method of asymmetric wireless communication according to claim 5 wherein at least one of said frequency bands and said frequency sub-bands are at least one of adjacent and separated by at least one of another frequency band and another frequency sub-band.

8. (canceled)

9. A wireless communication device for asymmetrical wireless communication, said wireless communication device comprising:
a receiver module for receiving communication transmission; and
a transmission module for transmitting communication transmission;
wherein at least one of:
said receiver module is operative to use a sub-band to receive said communication transmission; and
said transmission module is operative to use a sub-band to transmit said communication transmission; and
wherein said wireless communication device is allocated at least one of:
a whole number of frequency bands in one direction and at least one sub-band in the opposite direction;
a first number of sub-bands in one direction and a different number of sub-bands in the opposite direction;
at least one sub-band in one direction and at least one sub-band in the opposite direction wherein said sub-bands in different directions have a different size; and
at least one frequency band and at least one sub-band in one direction and a different number of at least one of frequency bands and sub-bands in the opposite direction;
wherein aid sub-bands are portions of a frequency band and all said frequency bands have the same bandwidth and FFT size.
